(19) United States
(12) Patent Application Publication
(10) Pub. No.: US 2025/0355623 A1
(43) Pub. Date: Nov. 20, 2025

(54) MULTIPLIER-ACCUMULATOR CIRCUIT WITH PATH MATCHING

(71) Applicant: British Cayman Islands Intelligo Technology Inc., Grand Cayman (KY)

(72) Inventors: Meng-Hsun WEN, Zhubei City (TW); Wei-Hsiang TSENG, Zhubei City (TW); Hong-Ching CHEN, Zhubei City (TW); Tsung-Liang CHEN, Zhubel City (TW)

(21) Appl. No.: 18/666,168

(22) Filed: May 16, 2024

(51) Int. Cl. G06F 7/487; G06F 7/527; G06F 7/533

(52) U.S. Cl. CPC G06F 7/4876; G06F 7/527; G06F 7/5336

(57) ABSTRACT

A multiplier-accumulator circuit is disclosed, comprising: a partial product generation (PPG) module, summation circuitry and path matching circuitry. The PPG module is configured to receive n multiplicands and n multipliers to generate multiple partial products according to a predefined multiplication algorithm. The summation circuitry coupled to the PPG module comprises S levels of compressors constructed from carry-save adders for summing up the multiple partial products and multiple previous accumulation terms to produce multiple current accumulation terms such that each bit of the multiple current accumulation terms has substantially the same path delay from inputs to outputs of the summation circuitry. The path matching circuitry comprising multiple components that receive a first clock signal to generate a second clock signal. The multiple components comprise either a first number of logic gates connected in series or the same cells as those embedded in the summation circuitry.

### BACKGROUND OF THE INVENTION

### Field of the Invention

The invention relates to multiplier-accumulator (MAC), and more particularly, to a multiplier-accumulator circuit with path matching.

### Description of the Related Art

In recent years, Multiply-Accumulate (MAC) unit is developing for various high performance applications. MAC unit is a fundamental block in the computing devices, especially Digital Signal Processor (DSP). FIG. 1A shows a diagram of a conventional MAC circuit. Referring to FIG. 1A, the conventional MAC circuit 100 includes a multiplier 110, a carry propagation adder (CPA) 120 and three registers 101˜103. Due to carry propagation in the multiplier 110 and the CPA 120, higher significant bits have longer paths, but lower significant bits have shorter paths, resulting in a long time delay between the most significant bit (MSB) and the least significant bit (LSB). The long time delay takes the outputs of the multiplier 110 and the CPA 120 a long time to settle; besides, the longer the time delay, the lower the clock rate. FIG. 1B is an exemplary timing diagram of the MAC circuit 100. Referring to FIGS. 1A and 1B, the registers 101˜103 are edge-triggered by the same clock signal clk and all the multiplication and addition operations are performed in the same clock phase (or the same active edge). Addressing the lower clock rate involves increasing the number of pipeline stages, accompanied by additional data path registers, but it results in higher power consumption.

Hence, it is desirable to increase the clock rate, improve the IR drop and reduce the power consumption for the MAC circuit.

### SUMMARY OF THE INVENTION

In view of the above-mentioned problems, an object of the invention is to provide a multiplier-accumulator circuit in order to increase the clock rate, improve the IR drop and reduce the power consumption.

One embodiment of the invention provides a multiplier-accumulator circuit. The circuit comprises: a partial product generation (PPG) module, summation circuitry and path matching circuitry. The PPG module is configured to receive n multiplicands and n multipliers to generate multiple partial products according to a predefined multiplication algorithm. The summation circuitry is coupled to the PPG module and comprises S levels of compressors constructed from carry-save adders for summing up the multiple partial products and multiple previous accumulation terms to produce multiple current accumulation terms such that each bit of the multiple current accumulation terms has a first data path delay from inputs to outputs of the summation circuitry, where n, S>=1. The path matching circuitry comprising multiple components that receive a first clock signal to generate a second clock signal. The multiple components comprise either a first number of logic gates connected in series or the same first cells as those embedded in the summation circuitry such that the first delay substantially equals a second data path delay from an input to an output of the path matching circuitry.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A shows a diagram of a conventional MAC circuit 100.

FIG. 1B is an exemplary timing diagram of the conventional MAC circuit 100.

FIG. 2A shows a diagram of a MAC circuit 200 according to an embodiment of the invention.

FIG. 2B shows a diagram of a MAC circuit 20 according to another embodiment of the invention.

FIG. 2C shows an exemplary diagram of encoding and PPG module 27A according to an embodiment of the invention.

FIG. 3A shows an example of long multiplication for M=N=6.

FIG. 3B shows a schematic diagram of a PPG 220A for long multiplication.

FIG. 3C is a flow chart of a partial product generation method for radix-2 Booth's multiplication.

FIG. 3D shows schematic diagrams of the encoding circuitry 260A, the PPG 220B and a first section 220s for radix-4 Booth's multiplication according to an embodiment of the invention.

FIG. 3E shows schematic diagrams of the encoding circuitry 260B, the PPG 220C and the first section 220s for radix-4 Booth's multiplication according to another embodiment of the invention.

FIG. 3F is an exemplary diagram showing a properly-hardwired connection between the PPG 220A and a 4-bit 3:2 compressor in the compressor tree 230.

FIG. 4A is a schematic diagram of the compressor tree 230 according to the invention.

FIG. 4B is an exemplary schematic diagram of the compressor tree 230A for T=M=N=8, k=2 and q=6.

FIG. 5A is a schematic diagram of the RNS adder 240 according to the invention.

FIGS. 5B-5C show two exemplary schematic diagrams of the RNS adders 240A-240B.

FIG. 6A shows exemplary schematic diagrams of the compressor tree 230B, the RNS adders 240D, a second section 230s and a third section 240s.

FIG. 6B shows exemplary schematic diagrams of a modified RNS adders 240E derived from FIG. 6A and a third section 240s.

FIG. 6C shows three examples for the third section 240s in FIG. 6B.

FIG. 7 shows a diagram of a MAC circuit 700 according to another embodiment of the invention.

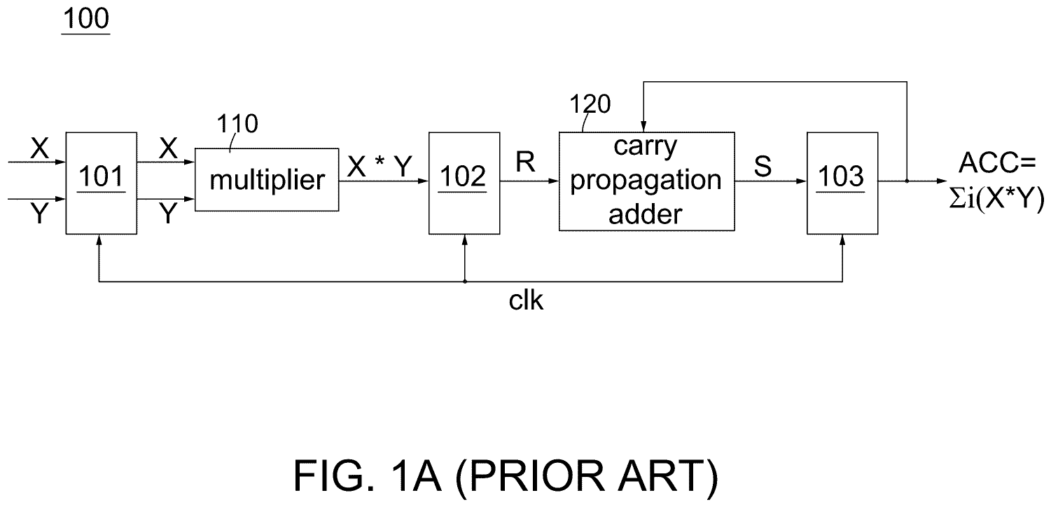

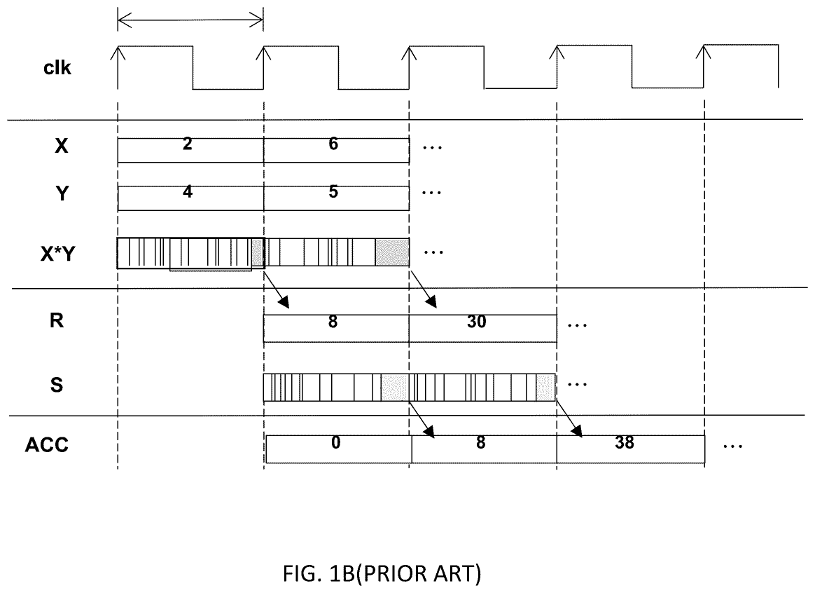

### DETAILED DESCRIPTION OF THE INVENTION

As used herein and in the claims, the term “and/or” includes any and all combinations of one or more of the associated listed items. The use of the terms “a” and “an” and “the” and similar referents in the context of describing the invention are to be construed to cover both the singular and the plural, unless otherwise indicated herein or clearly contradicted by context. Throughout the specification, the same components with the same function are designated with the same reference numerals.

A feature of the invention is that carry-free addition processes carried out by multiple carry-save adders (CSAs) included in a compressor tree 230 and a redundant number system (RNS) adder 240 and a path-symmetric structure/configuration of the compressor tree 230 result in substantially the same data path delay for each bit of sum terms S and carry terms C. Another feature of the invention is to pad corresponding logic gates or the same cells in a path matching circuit 210/210A as those embedded in a partial product generator (PPG) 220, the compressor tree 230 and the RNS adder 240 to cause the data path delay and the clock path delay to be substantially equal (hereinafter called “exact path matching (EPM)” feature). With substantially the same data path delay for each bit of the sum terms S and the carry terms C, a high clock rate, up to 1.2 GHz (or even higher), for the MAC circuit 200/700/20 of the invention can be reached, eliminating the need of dividing each clock cycle into multiple pipeline stages (or without adding registers), and thus saving the circuit size by around 50%. Due to the fact that the CSAs operate without complicated carry propagation paths, repeated charging and discharging in the MAC circuit 200/700/20 can be significantly avoided, resulting in a great saving in power consumption and a significant improvement in IR drop. Besides, with the EPM feature, the data signals S/C and the clock signal clk′ are substantially at the same time outputted from the RNS adder 240 and the path matching circuit 210/210A as synchronous-pair of signals, and allow the register 202 to sample the received data signals S/C using the clock signal clk′ at high speeds and high reliability. The invention is qualified for high-speed data signaling.

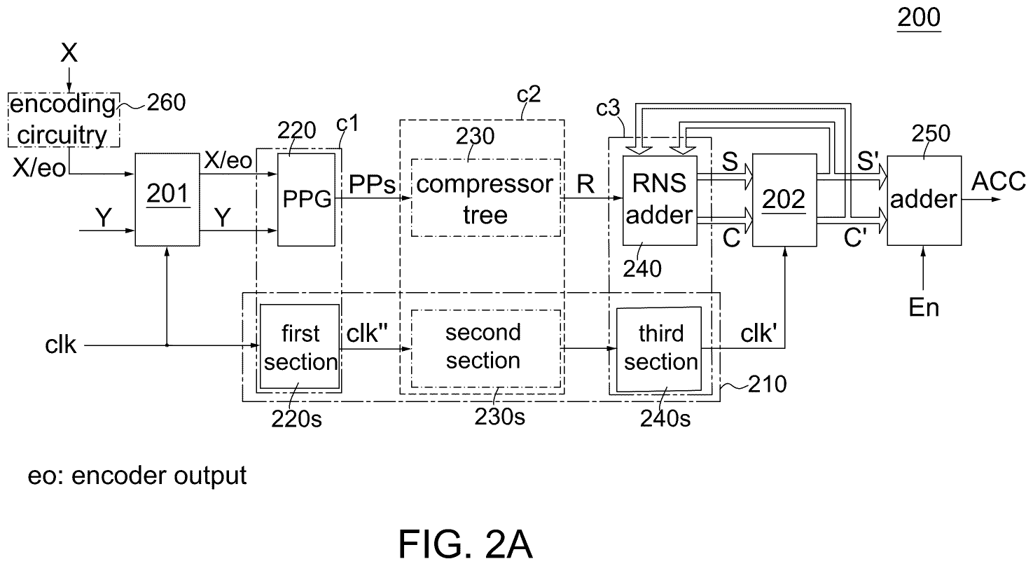

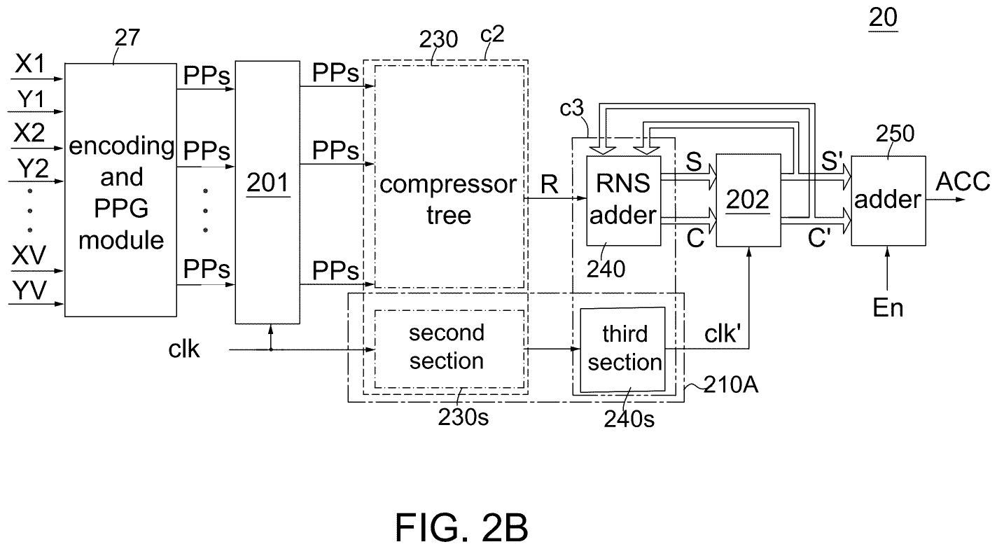

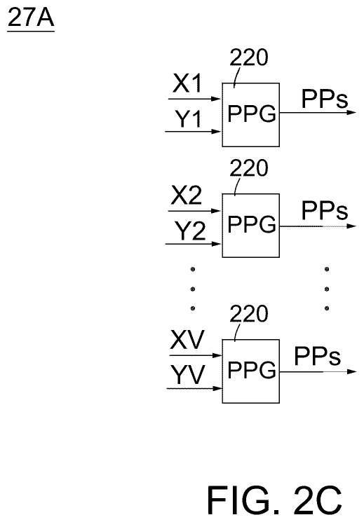

FIG. 2A shows a schematic diagram of a MAC circuit according to the invention. Referring to FIG. 2A, the MAC circuit 200 of the invention includes a PPG 220, a compressor tree 230, a RNS adder 240, a path matching circuit 210, an encoding circuitry 260, an adder 250 and two registers (or latches) 201˜202. The encoding circuitry 260 is optional depending on different multiplication algorithms, and may be located either prior to the register 201 or inside the PPG 220. The compressor tree 230 may be either separated from the RNS adder 240 or merged into the RNS adder 240. For purpose of clarity and ease of description, the MAC circuit 200 is described herein with the assumption that the encoding circuitry 260 is located prior to the register 201 while the compressor tree 230 is separated from the RNS adder 240. The encoding circuitry 260 and the PPG 220 are used to generate multiple partial products for a multiplicand Y and a multiplier X based on a predefined multiplication algorithm, such as conventional long multiplication, original Booth's multiplication algorithm (radix=2), modified Booth's multiplication algorithm (radix>2) and the like. The encoding circuitry 260 and the PPG 220 may be implemented by a software program, hardware (e.g., field programmable gate array (FPGAs) or application specific integrated circuit (ASICs)), or by a combination of the hardware and the software program hardware.

The compressor tree 230 adds the multiple partial products up to generate a final product R (may include one or more terms) of the multiplicand Y and the multiplier X. The RNS adder 240 adds the final product R and previous accumulation terms S′ and C′ to produce current accumulation terms S and C. The adder 250 adds the sum terms S′ and the carry terms C′ in response to an asserted control signal En to generate a final accumulation value ACC. The path matching circuit 210 includes a first section 220s, a second section 230s and a third section 240s.

A multiplicand Y with M digits and a multiplier X with N digits in binary format are respectively given by

$$\begin{matrix}Y = {y}_{M - 1} {2}^{M - 1} + {y}_{M - 2} {2}^{M - 2} + ⋯ + {y}_{1} {2}^{1} + {y}_{0} {2}^{0} = ( {y}_{M - 1} , {y}_{M - 2} , … , {y}_{1} , {y}_{0} ) b ; \\ X = {x}_{N - 1} {2}^{N - 1} + {x}_{N - 2} {2}^{N - 2} + ⋯ + {x}_{1} {2}^{1} + {x}_{0} {2}^{0} = ( {x}_{N - 1} , {x}_{N - 2} , … , {x}_{1} , {x}_{0} ) b , where {y}_{j} = [ 0 , 1 ] , for j = 0 , … , ( M - 1 ) , {x}_{i} = [ 0 , 1 ] , for i = 0 , … , ( N - 1 )\end{matrix}$$

and the symbol “b” indicates the integer number in the binary format. The final product R for the multiplicand Y and the multiplier X can be written as follows:

$$R = ( {\sum }_{j = 0}^{M - 1} {y}_{j} {2}^{j} ) \times ( {\sum }_{i = 0}^{N - 1} {y}_{i} {2}^{i} ) = {\sum }_{i = 0}^{N - 1} {\sum }_{j = 0}^{M - 1} {x}_{i} {y}_{j} {2}^{i + j} .$$

The MAC circuits 200/700/20 of the invention are generally applicable to any combinations of unsigned integers and signed integers for the multiplicands Y/Y1˜YV and the multipliers X/X1˜XV. For purposes of clarity and ease of description, only unsigned integers for the multiplicands Y/Y1˜YV and the multipliers X/X1˜XV are described herein.

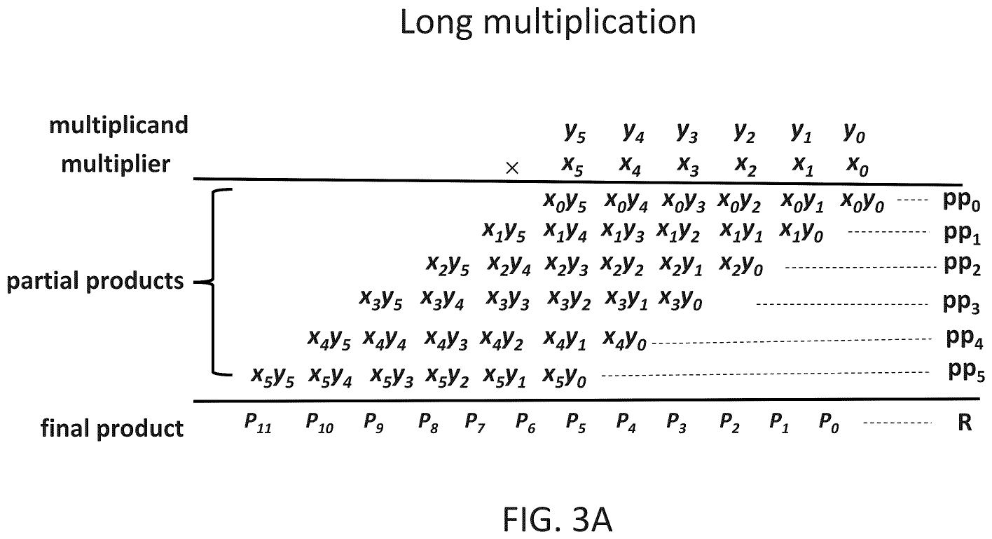

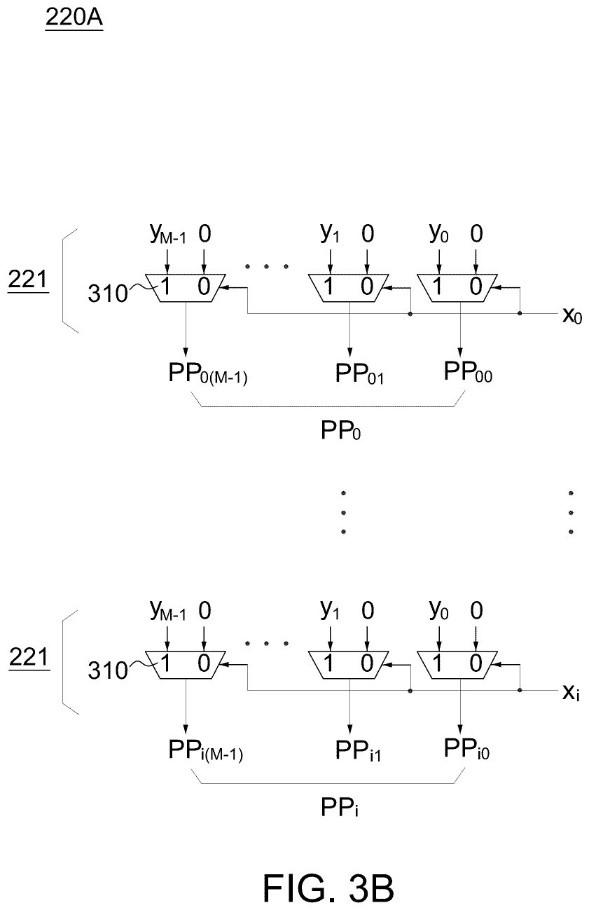

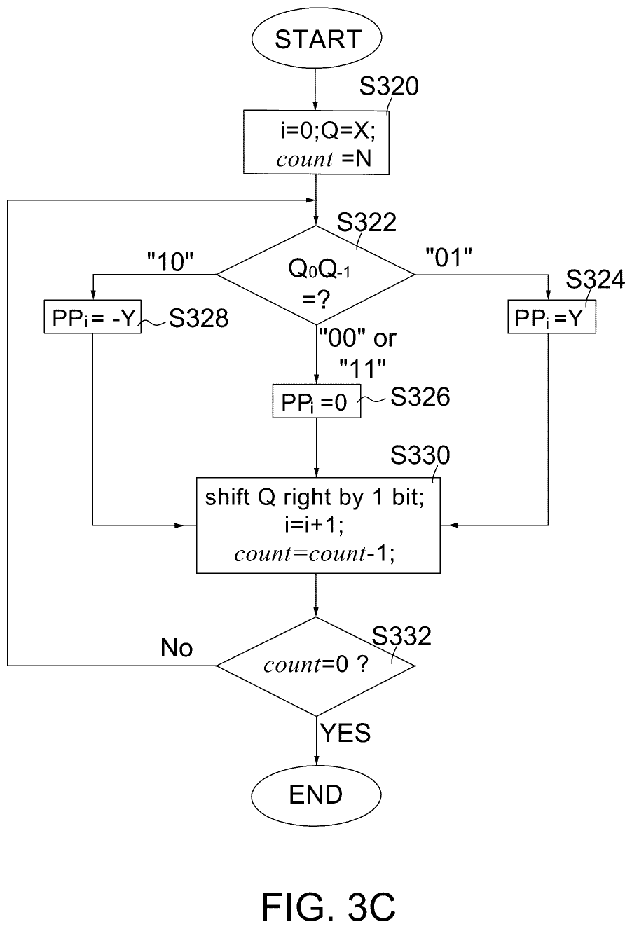

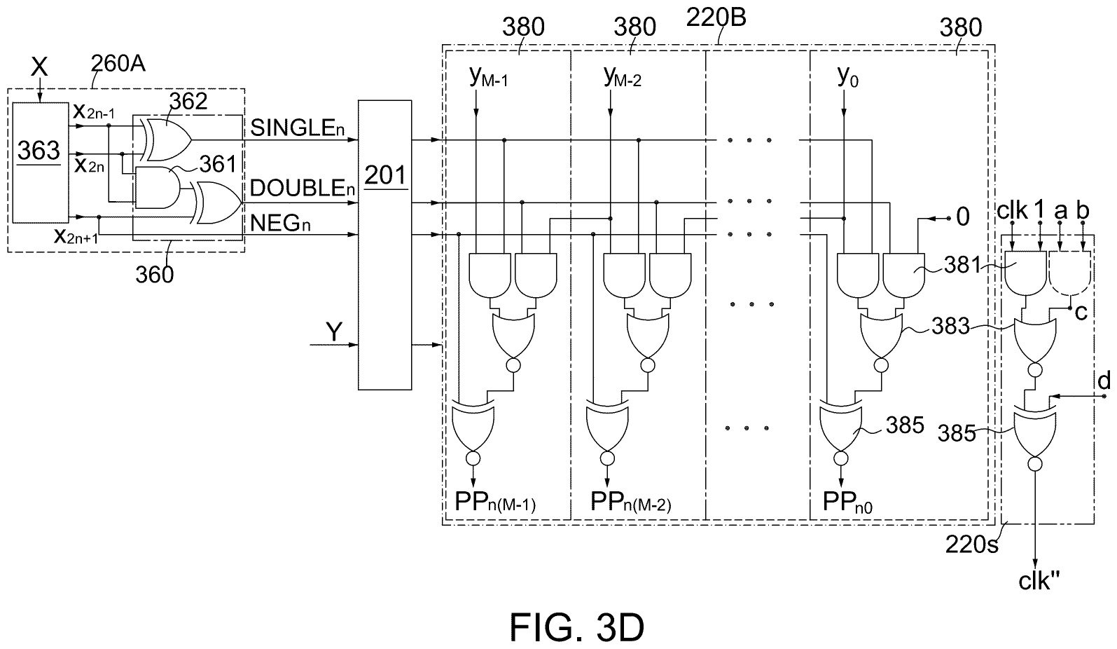

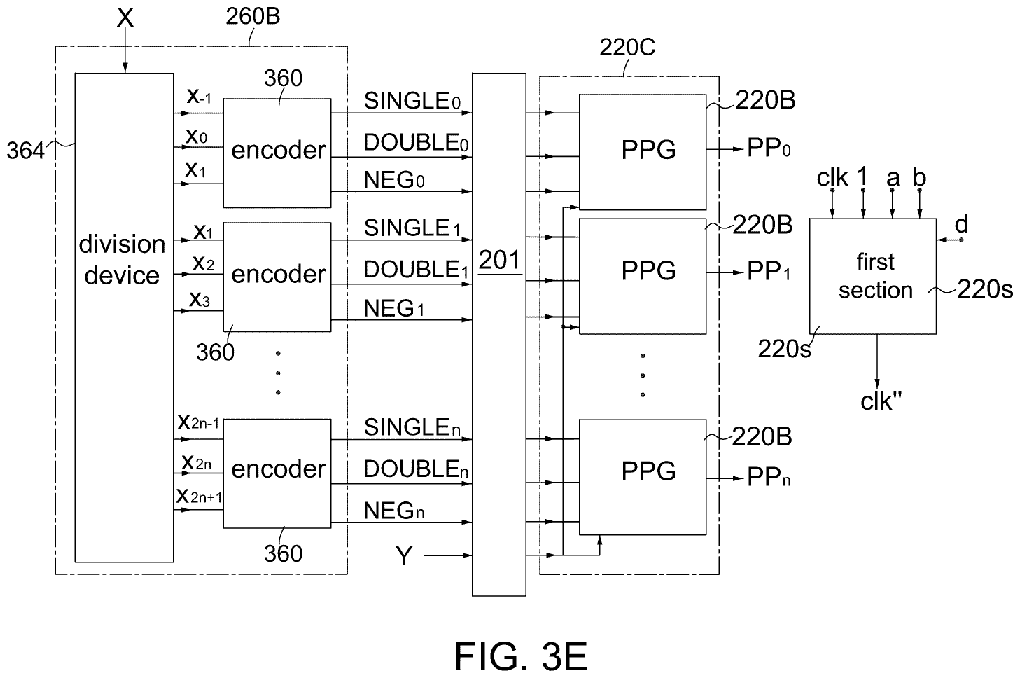

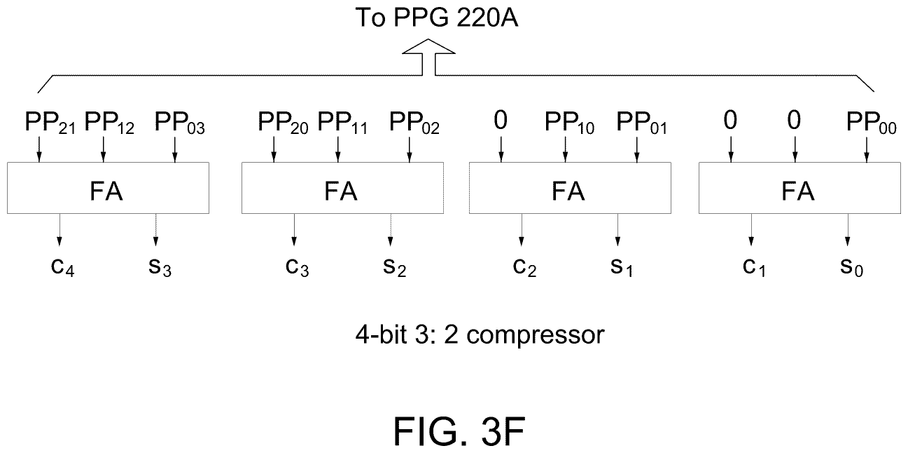

FIG. 3A shows an example of long multiplication for the multiplicand Y and the multiplier X with M=N=6. Referring to FIG. 3A, with the long multiplication approach, the number of partial products PP₀˜PP₅ is exactly the number of columns in the multiplier X. The six partial products PP₀˜PP₅ are finally added to obtain the final product R. FIG. 3B shows a schematic diagram of a PPG 220A for long multiplication. In an embodiment of long multiplication, a PPG 220A includes (i+1) row generators 221, each including M multiplexers 310 to generate a partial product PPᵢ corresponding to a bit value xᵢ of the multiplier X, where 0<=i<=(N−1). For example, if i=3 and N=8, the PPG 220A needs to operate two times to generate a total of eight partial products PP₀˜PP₇. However, the M multiplexers 310 included in each row generator 221 are only utilized as embodiments and not limitations of the invention. In the actual implementations, any other components (such as a number M of AND gates included in each row generator 221) can be used to implement the PPG 220A for long multiplication and this also falls in the scope of the invention.

On the other hand, the speed of multiplication can be improved by reducing the number of partial products. Performing Booth's multiplication algorithm is faster than performing the long multiplication approach and Booth's multiplication algorithm gives a procedure for multiplying binary integers in signed 2's complement representation in efficient way, i.e., less number of additions/subtractions required. The number of partial products is inversely proportional to the radix-k of Booth encoding by a factor of log₂(k), which means that the number of partial products is halved while radix k increases four times, requiring fewer steps to produce the same result.

FIG. 2B shows a schematic diagram of a MAC circuit according to another embodiment of the invention. Referring to FIG. 2B, the MAC circuit 20 of the invention includes an encoding and PPG module 27, a compressor tree 230, a RNS adder 240, a path matching circuit 210A, an adder 250 and two registers (or latches) 201˜202. The encoding and PPG module 27 receives V multiplicands (Y1˜YV) and V multipliers (X1˜XV), where V>=1. The encoding and PPG module 27 may be implemented by a software program, hardware (e.g., FPGAs or ASICs), or by a combination of the hardware and the software program. In the embodiment of FIG. 2C, the encoding and PPG module 27A is implemented with hardware, i.e., V PPGs 220 with/without V encoding circuitries 260. For example, depending on different multiplication algorithms, the encoding and PPG module 27A may be implemented with V PPGs 220A, V encoding circuitries 260A with V PPGs 220B, or V encoding circuitries 260B with V PPGs 220C. In an alternative embodiment, the encoding and PPG module 27 is implemented with a processor and a storage medium (not shown). The storage medium stores multiple instructions of a software program to be executed by the processor to perform all the steps of a partial product generation method according to a predefined multiplication algorithm, such as conventional long multiplication, original Booth's multiplication algorithm (radix=2), modified Booth's multiplication algorithm (radix>2) and the like.

FIG. 3C is a flow chart of a partial product generation method for radix-2 Booth's multiplication. The partial product generation method in FIG. 3C is performed by the processor in the encoding and PPG module 27. It is assumed that Q is a N-bit register and Q₋₁ is a 1-bit register, where i and count are variables. The partial product generation method in FIG. 3C is well known in the art, and thus the detailed description is omitted herein.

FIG. 3D shows schematic diagrams of the encoding circuitry 260A and the PPG 220B for radix-4 Booth's multiplication according to the invention. Referring to FIG. 3D, the encoding circuitry 260A includes an encoder 360 and a division device 363. The encoding circuitry 260A is configured to recode the multiplier X to generate a three-bit encoded output (SINGLEₙ, DOUBLEₙ and NEGₙ) that is used by the PPG 220B to form the partial products PP₀˜P_{PU-1}, where U=(N/2)+1 if N is an even integer and U=((N+1)/2)+1 if N is an odd integer. The encoder 360 includes a one AND gate 361 and two XOR gates 362. The PPG 220B includes M column generators 380, each including two AND gates 381, one NOR gate 383 and one XNOR gate 385. However, the AND gate 361 and the two XOR gates 362 included in the encoder 360 and the two AND gates 381, the NOR gate 383 and the XNOR gate 385 included in each column generators 380 are only utilized as embodiments and not limitations of the invention. In actual implementations, any other components can be used for the encoder 360 and any other components can be used for the column generator 380; this also falls in the scope of the invention. After receiving the multiplier X, the division device 363 is configured to pad the LSB (x₋₁) with one zero, divide the (N+1) bits of the X value into multiple overlapping groups of three bits (with one bit overlap) and sequentially output the multiple overlapping groups of three bits x₂ₙ₋₁, X₂ₙ and X₂ₙ₊₁, where 0<=n<=(U−1). The encoder 360 encodes the three bits X₂ₙ₋₁, x₂ₙ and X₂ₙ₊₁ into a three-bit encoded output (SINGLEₙ, DOUBLEₙ and NEGₙ), representing a radix-4 digit, i.e., one of the following five signed digits {2, 1, 0, −1, −2}. Then, the M column generators 380 generate a partial product PPₙ(including PP_{n(M-1)}˜PPₙ₀) based on the three-bit encoded output and the multiplicand Y In this manner, the encoding circuitry 260A and the PPG 220B operate U times to generate U partial products PP₀˜PP_{U-1}. Here, the division device 363 may be implemented by a shifter register that receives the X value and pads the LSB (x₋₁) with one zero to output a first group of three bits (x₋₁, x₀ and x₁), and then shifts the X value to the left by two bits to output a group of three bits (X₂ₙ₋₁, x₂ₙ and X₂ₙ₊₁) at a time until all bits of the X value are outputted, where 0<=n<=(U−1).

FIG. 3E shows schematic diagrams of the encoding circuitry 260B, PPG circuitry 220C and the first section 220s for radix-4 Booth's multiplication according to another embodiment of the invention. In comparison with the circuit in FIG. 3D that generates a single partial product at a time, the circuit in FIG. 3E generates multiple partial products at the same time. Referring to FIG. 3E, the encoding circuitry 260B includes (n+1) encoders 360 and a division device 364 while the PPG circuitry 220C includes (n+1) PPGs 220B to generate (n+1) partial products, where 0<=n<=(U−1). After receiving the multiplier X, the division device 364 is configured to pad the LSB (x₋₁) with one zero, divide the (N+1) bits of the X value into multiple overlapping groups of three bits (with one bit overlap) and output (n+1) overlapping groups of three bits at a time. Each encoder 360 receives an overlapping group of three bits (x₂ᵢ₋₁, x₂ᵢ and x₂ᵢ₊₁) from the division device 364 and encodes the three bits into a three-bit encoded output (SINGLEᵢ, DOUBLEᵢ and NEGᵢ), where 0<=i<=n. Finally, each PPG 220B receives a corresponding three-bit encoded output (SINGLEᵢ, DOUBLEᵢ and NEGᵢ) and generates a corresponding partial product (PPᵢ). For example, if n=3 and N=8, then U=5, so the encoding circuitry 260B and the PPG circuitry 220C need to operate twice to generate a total of five partial products PP₀˜PP₄. Here, the division device 364 may be implemented by a shifter register that receives the X value and pads the LSB (x₋₁) with one zero to output (n+1) groups of three bits (x₂ᵢ₋₁, x₂ᵢ and x₂ᵢ₊₁) and then shifts the X value to the left by (2n+1) bits to output (n+1) groups of three bits at a time until all bits of the X value are outputted, where 0<=i<=n, and 0<=n<=(U−1). The division device 363/364 may be implemented by a software program (i.e., by a processor and a storage media).

In brief, depending on the defined multiplication algorithm and N being even or odd, the total of the partial products outputted from the PPG 220 is varied, where N denotes a bit width of the multiplier X or the number of bits in the multiplier X in binary format. Although the above embodiments of the encoding circuitry 260/260A˜B and the PPG 220/220A˜C have been described in terms of long multiplication, radix-2 and radix-4 Booth encoding, it should be understood that embodiments of the invention are not so limited, but are generally applicable to any multiplication algorithm, such as higher radix Booth encoding (radix>4).

Referring back to the examples of FIGS. 3A-3B, before the partial product PPᵢ is fed to the compressor tree 230, the partial product PPᵢ needs to be shift left by i bits relative to the partial product PP₀, where 1<=i<=(N−1). As to the examples of FIGS. 3D-3E, before the partial product PPₙ is fed to the compressor tree 230, the partial product PPₙ need to be shift to the left by 2n bits relative to the partial product PP₀, where 1<=n<=(U−1). In an embodiment, a shift register (not shown) coupled between the PPG 220 and the compressor tree 230 is used to shift the partial products to the left by predefined bits. In an alternative embodiment, left-shifting the partial products by predefined bits can be achieved through a properly-hardwired connection between the output terminals of the PPG 220 and the input terminals of the compressor tree 230. For example, as shown in FIG. 3F, it is assumed that three partial products PP₀˜PP₂ from the PPG 220A are fed to a 4-bit 3:2 compressor of the compressor tree 230 for long multiplication. The properly-hardwired connection between the output terminals of the PPG 220A and the input terminals of the 4-bit 3:2 compressor in the compressor tree 230 is equivalent to left-shifting the partial product PP₁ by one bit and left-shifting the partial product PP₂ by two bits relative to the partial product PP₀.

A carry-save adder (CSA) is a parallel ensemble of multiple full-adders (FAs) without any horizontal connection. Thus, the CSA adds numbers in a carry-free manner (without carry propagation) and the total delay of the CSA is equal to the total delay of a single FA cell. In view of the above features, the compressor tree 230 and the RNS adder 240 of the invention are circuits constructed from CSAs.

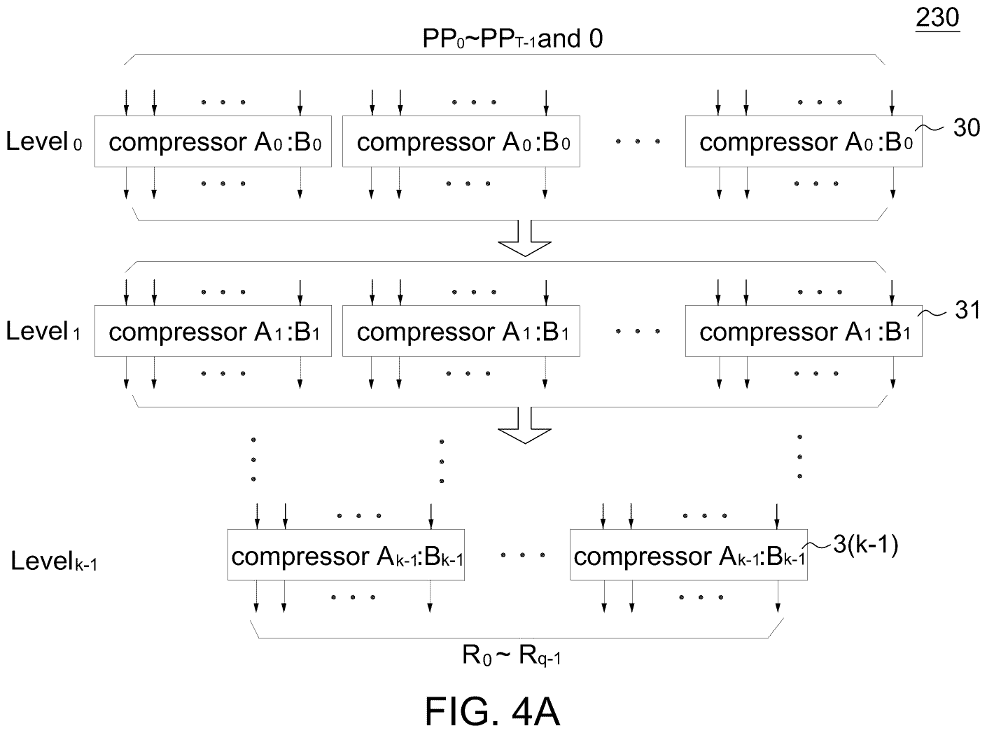

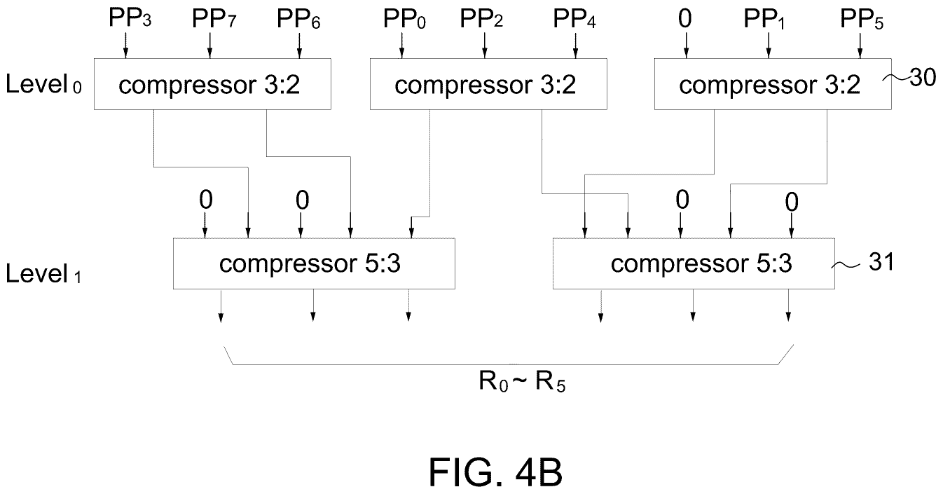

FIG. 4A is a schematic diagram of the compressor tree 230 according to the invention. Referring to FIG. 4A, the compressor tree 230 includes k levels/stages of compressors or CSAs, where k>=0. Here, “k=0” indicates the compressor 230 is merged into the RNS adder 240. Level 0 includes multiple W₀-bit A₀:B₀ compressors (or CSAs) 30 while Level i includes one or more Wᵢ-bitAᵢ:Bᵢ compressors (or CSAs) 3i, where 1<=i<=(k−1), W₀>=max(M,N)+1, Aᵢ>Bᵢ and Wᵢ>=Wᵢ₋₁. The k levels of compressors or CSAs are arranged in a path-symmetric configuration/structure such that each bit of q terms R₀˜R_{q-1} of the final product R has substantially the same data path delay from level 0 to level (k−1), thereby to increase the clock rate.

The total of input terminals for all the compressors 30 in level 0 is greater than or equal to the total T of partial products PP₀˜PP_{T-1} from the PPG 220 that are arbitrarily fed to the input terminals of the compressors 30, where T>=1. If the total of input terminals of the compressors 30 in Level 0 is greater than the total T of partial products PP₀˜PP_{T-1}, a number “0” is fed to each of the spare/rest input terminals of the compressors 30. The total of input terminals of the compressors 3i in Level i is greater than or equal to the total of output terminals of the compressors 3 (i−1) in Level (i−1). The outputs of the compressors 3 (i−1) in Level (i−1) are arbitrarily fed to the input terminals of the compressors 3i in Level i. If the total of input terminals of the compressors 3i in Level i is greater than the total of output terminals of all the compressors 3 (i−1) in Level (i−1), the number “0” is fed to each of the spare/rest input terminals of the compressors 3i in Level i. Due to Aᵢ>Bᵢ, after the k-level compression, the T partial products PP₀˜PP_{T-1} are compressed into q terms R₀˜R_{q-1} for the final product R of the multiplicand Y and the multiplier X, where T>q. FIG. 4B is an exemplary schematic diagram of the compressor tree 230A for T=M=N=8, k=2 and q=6. In the example of FIG. 4B, there are three 16-bit 3: 2 compressors 30 in Level 0 and two 16-bit 5:3 compressors 31 in Level 1. Since the total of input terminals of the compressors 30 in Level 0 is greater than the total T(=8) of partial products PP₀˜PP₇ from the PPG 220, a number “0” is fed to the spare/rest input terminals of the compressors 30 in Level 0. Since the total of input terminals of the compressors 31 in Level 1 is greater than the total of output terminals of the compressors 30, the number “0” is fed to each of the spare/rest input terminals of the compressors 31. Finally, the eight partial products PP₀˜PP₇ are compressed into six terms R₀˜R₅, which are the carry terms and the sum terms of the final product R for the multiplicand Y and the multiplier X. Obviously, each bit of the final product R₀˜R₅ has substantially the same data path delay from level 0 to level 1.

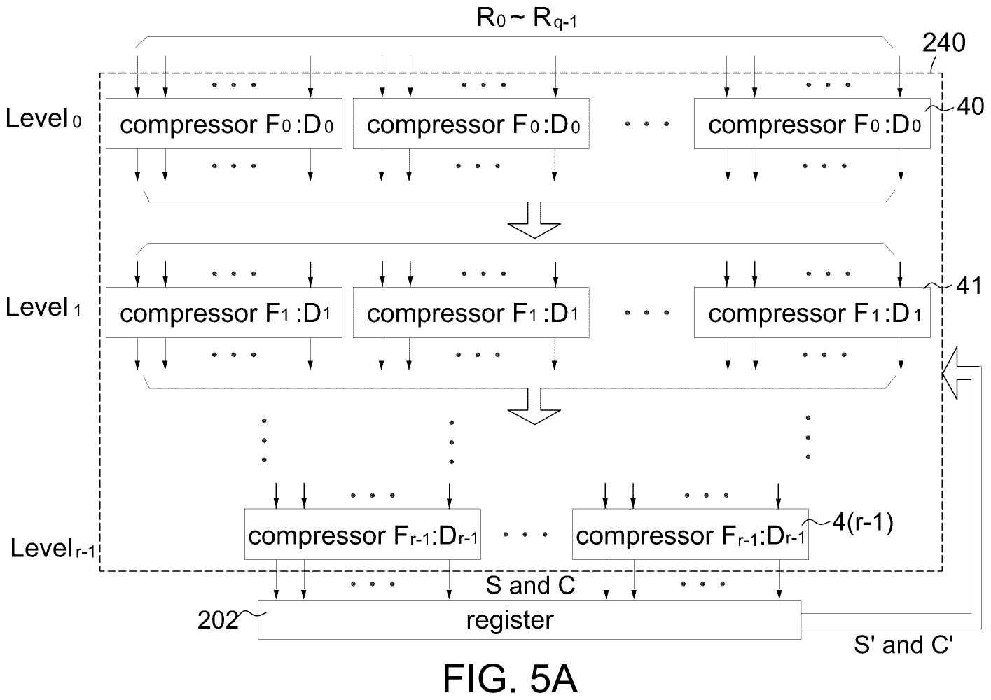

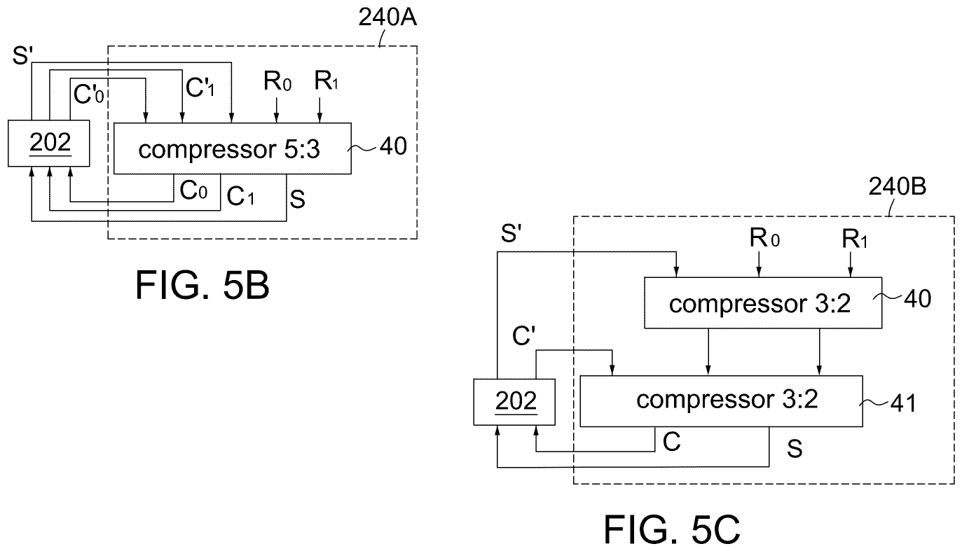

FIG. 5A is a schematic diagram of the RNS adder 240 according to the invention. Referring to FIG. 5A, the RNS adder 240 includes r levels/stages of compressors or CSAs, where r>=1. Each level i includes one or more Eᵢ-bit Fᵢ:Dᵢ compressors (or CSAs) 4i, where 0<=i<=(r−1), Fᵢ>Dᵢ and Eᵢ>=Eᵢ₋₁. To avoid carry propagation, the RNS adder 240 adds the q terms R₀˜R_{q-1} of the final product and the carry terms and the sum terms of the register 202 such that each bit of the final carry terms C and the final sum terms S has substantially the same data path delay from level 0 to level (r−1). One or more outputs (S′ and C′) of the register 202 may be fed to one or more levels of the RNS adder 240. In a preferred embodiment, the one or more outputs (S′ and C′) of the register 202 are fed to the higher levels of the RNS adder 240 for a shorter data path delay.

The total of input terminals for all the compressors 40 in level 0 is greater than or equal to the total of the q terms R₀˜R_{q-1} of the final product R from the compressor tree 230. The q terms R₀˜R_{q-1} and zero or more outputs (S′ and C′) of the register 202 are arbitrarily fed to the input terminals of the compressors 40 in Level 0. If the total of the input terminals of the compressors 40 is greater than a sum (=q+q1) of q and the number q1 of the zero or more output terminals of the register 202 (i.e., the q1 output terminals are coupled to the input terminals of the compressors 40), a number “0” is fed to each of the spare/remaining input terminals of the compressors 40. The outputs of the compressor 4 (i−1) in level (i−1) and zero or more outputs of the register 202 are arbitrarily fed to the input terminals of the compressor 4i in Level i, where 1<=i<=(r−1). If the total of the input terminals of the compressors 4i is greater than a sum (=t1+t2) of the total t1 of the outputs of the compressors 4 (i−1) and a number t2 of the zero or more outputs of the register 202 (i.e., the t2 output terminals are coupled to the input terminals of the compressors 4i), a number “0” is fed to each of the spare/remaining input terminals of the compressors 4i. After the r-level processing, the q terms R₀˜R_{q-1} of the final product R are compressed into one or more sum terms S and one or more carry terms C. FIGS. 5B-5C show two exemplary schematic diagrams of the RNS adders 240A-240B. In the example of FIG. 5B, the RNS adder 240A includes a 5:3 compressor 40 that receives a sum term S′ and two carry terms C₀′ and C₁′ from the register 202 and two terms R₀˜R₁ of the final product R from the compressor tree 230 to generate the sum term S and two carry terms C₀ and C₁. In the example of FIG. 5C, the RNS adder 240B includes two 3:2 compressors 40 and 41. The 3:2 compressor 40 receives a sum term S′ from the register 202 and two terms R₀˜R₁ from the compressor tree 230 while the 3:2 compressor 41 receives a carry term C′ from the register 202 and two outputs from the 3:2 compressor 40 to generates the sum term S and the carry term C. Obviously, each bit of the final carry terms C and the final sum terms S has substantially the same data path delay from level 0 to level 1 in FIG. 5C.

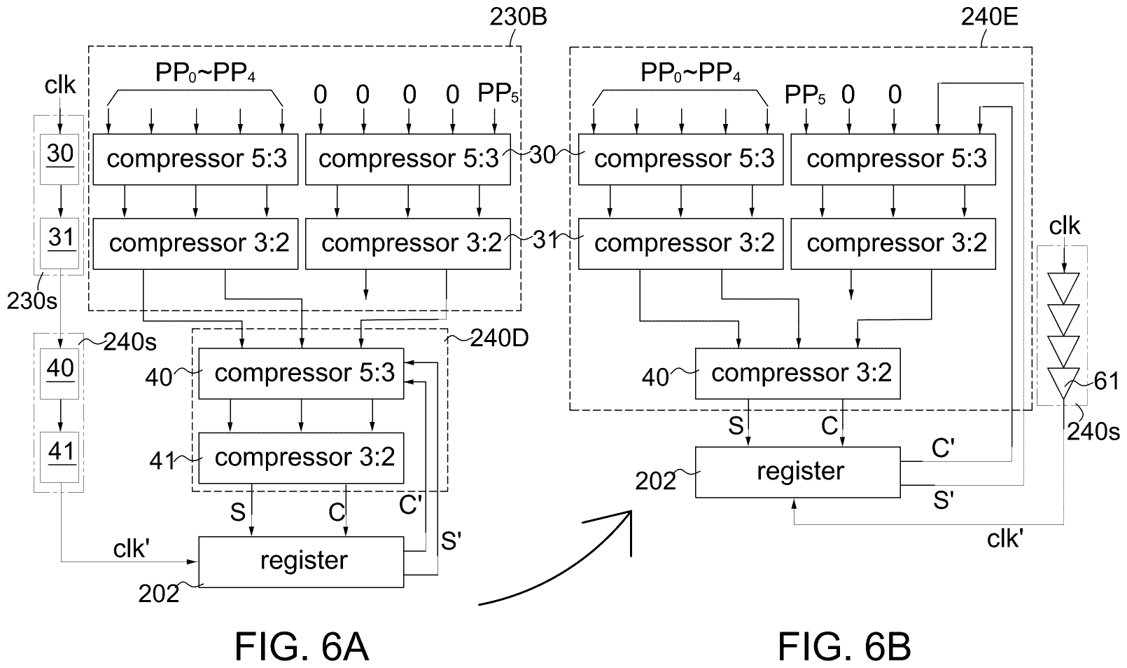

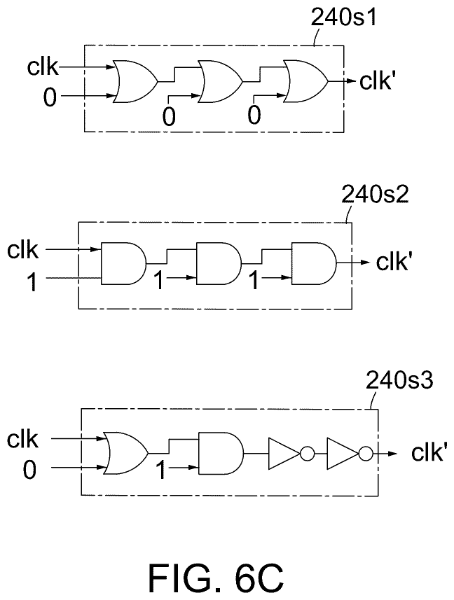

In an embodiment, a transformation is made to form a modified RNS adder by merging the compressor tree 230 into the RNS adder 240. FIG. 6A shows exemplary schematic diagrams of the compressor tree 230B, the RNS adders 240D, a second section 230s and a third section 240s. FIG. 6B shows exemplary schematic diagrams of the modified RNS adders 240E and a third section 240s derived from FIG. 6A. As shown in FIGS. 6A and 6B, the compressor tree 230B is merged into the RNS adder 240D to form a modified RNS adder 240E. Similar to the compressor tree 230B, the modified RNS adder 240E also has a path-symmetric structure such that each bit of the sum S and the carry C has substantially the same data path delay from the compressor 30 to the compressor 40. Advantageously, in comparison with FIG. 6A, each bit of the sum term S and the carry term C in FIG. 6B has a shorter data path delay.

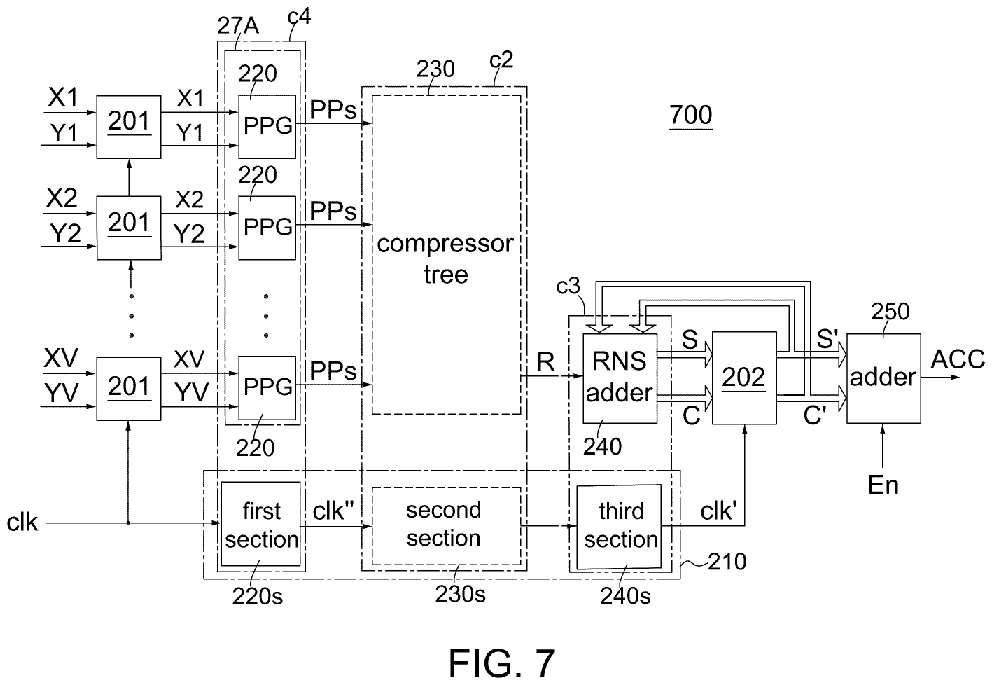

Referring back to FIG. 2A, the PPG 220 and the first section 220s are located at the same chip/FPGA/ASIC c1, the compressor tree 230 and the second section 230s are located at the same chip/FPGA/ASIC c2, the RNS adder 240 and the third section 240s are located at the same chip/FPGA/ASIC c3. The components of the path matching circuit 210 are varied according to the components included in the PPG 220, the compressor tree 230 and the RNS adder 240. In fact, each of the first section 220s, the second section 230s and the third section 240s includes either multiple logic gates or the same cells as those embedded in the PPG 220, the compressor tree 230 and the RNS adder 240 such that the data path delay and the clock path delay between the chips c1 and c3 are substantially equal. Please also note that the second section 230s exists only if the compressor tree 230 exists. For the embodiment in FIG. 2B, since the encoding and PPG module 27 is located before the register 201, the first section 220s is removed such that the data path delay and the clock path delay between the chips c2 and c3 are substantially equal. Since the compressor tree 230 may be merged into the RNS adder 240, the compressor tree 230 and the second section 230s are optional and represented by dash lines in FIGS. 2A-2B and 7.

For a case of padding the same cells in the same chip/FPGA/ASIC, referring back to FIGS. 3D and 3E, since the data signals Y/SINGLEn/DOUBLEn/NEGn go through the AND gate 381, one NOR gate 383 and one XNOR gate 385 in each column generator 380, the clock signal clk would also go through the same cells in the first section 220s to cause the data path delay and the clock path delay to be substantially equal. Accordingly, the first section 220s includes one or two AND gates 381, a NOR gate 383 and a XNOR gate 385. Besides, each gate has a proper input (a, b, c, d) that allows the clock signal clk to go in and get out of the first section 220s. The right AND gate 381 is optional and thus represented by dash lines. For example, the first section 220s may include only one AND gate 381 with the terminal c set to 0; alternatively, the first section 220s may include two AND gate 381 with the terminals a and b set to (0,0), (0,1) or (1,0); an input terminal d may be set to 0 or 1, but setting the terminal d to 0 is preferred because the clock signals clk and clk″ would be aligned with the same clock edge. In the same manner, since the data signals PP₀˜PP₅ go through the compressor tree 230B and the RNS adder 240D in FIG. 6A, the clock signal clk would also go through the same cells in the second and the third sections 230s and 240s to cause the data path delay and the clock path delay to be substantially equal. Correspondingly, in FIG. 6A, the second section 230s includes the 5:3 compressor 30 and the 3:2 compressor 31 (each compressor 30/31 with one input terminal receiving the clock signal clk and the other input terminals being grounded) while the third section 240s includes the 5:3 compressor 40 and the 3:2 compressor 41 (each compressor 40/41 with one input terminal receiving the clock signal clk and the other input terminals being grounded) (not shown). An advantage of padding the same cells in the same chip/FPGA/ASIC is that the data path delay and the clock path delay would be shorten or prolonged in the same manner due to a reduction of circuit performance caused by PVTA (process, voltage, temperature and aging) variations.

For a case of padding logic gates in the same chip/FPGA/ASIC, an electronic design automation (EDA software tool), such as Static timing analysis (STA), is used during digital system design to compute the expected delay to ensure that the data path delay and the clock path delay are substantially equal. The logic gates include, without limitations, clock buffers, inverters, AND gates, OR gates, XOR gates, NOR gates, NAND gates and the like, or a combination of various logic gates. Depending on different logic gates with different path delays, the numbers of logic gates are varied in the sections 220s˜240s. For example, as shown in FIG. 6B, a clock path delay about “how many clock buffers 61 in the third sections 240s the clock signal clk should go through” needs to be computed in advance during digital system design by an EDA tool (such as STA) in order for the clock path delay to be substantially equal to the data path delay for the data signals PP₀˜PP₅ going through the three compressors 30, 31 and 40 in the modified RNS adder 240E. In this example, it is determined in advance that the clock path delay for the clock signal clk to go through “four” clock buffers 61 in the section 240s is equal to the data path delay for the data signals PP₀˜PP₅. For another example, it is assumed that the data path delay for PP₀˜PP₅ in FIG. 6B is equal to the clock path delay for the clock signal clk to go through three OR gates with one input terminal being fed with zeros in the third section 240s1, the clock path delay for the clock signal clk to go through three AND gates with one input terminal being fed with ones in the third section 240s2 and the clock path delay for the clock signal clk to go through a combination of four different logic gates in the third section 240s3 in FIG. 6C. Accordingly, the third section 240s in FIG. 6B can be replaced by one of the third sections 240s1˜240s3 in FIG. 6C. In the same way, the numbers of logic gates included in the sections 220s and 230s can be also determined in advance. It is noted that the numbers of logic gates may be varied in the sections 220s, 230s and 240s depending on the respective data path delays in the PPG 220, the compressor tree 230 and the RNS adder 240. However, since the logic gates in the sections 220s, 230s and 240s are different from the cells/components used in the PPG 220, the compressor tree 230 and the RNS adder 240, PVTA variations may result in a difference between the data path delay and the clock path delay.

FIG. 7 shows a diagram of a MAC circuit according to another embodiment of the invention. Referring to the embodiment of FIG. 7, the MAC circuit 700 of the invention includes the encoding and PPG module 27A, a compressor tree 230, a RNS adder 240, a path matching circuit 210, an adder 250 and (V+1) registers (or latches) 201˜202. In an embodiment, depending on different multiplication algorithms, the encoding and PPG module 27A may be implemented with V PPGs 220 with/without V encoding circuitries 260 (such as V PPGs 220A, V encoding circuitries 260A with V PPGs 220B, or V encoding circuitries 260B with V PPGs 220C). In an alternative embodiment, the V encoding circuitries 260A/B are excluded from the encoding and PPG module 27A and located prior to the registers 201 (not shown). The V PPGs 220 and the first section 220s are located at the same chip/FPGA/ASIC c4. The MAC circuits 200 and 700 operates in a similar manner. The difference is that the MAC circuit 200 deals with one multiplicand Y and one multiplier X, but the MAC circuit 700 deals with V multiplicands (Y1˜YV) and V multipliers (X1˜XV), where V>1.

In sum, the data path delay and the clock path delay being substantially equal allows the register 202 to sample the received data signals S/C using the clock signal clk′ at high speeds and high reliability, thus facilitating high-speed data signaling.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A multiplier-accumulator circuit, comprising:
a partial product generation (PPG) module configured to receive n multiplicands and n multipliers to generate multiple partial products according to a predefined multiplication algorithm;
summation circuitry coupled to the PPG module and comprising S levels of compressors constructed from carry-save adders for summing up the multiple partial products and multiple previous accumulation terms to produce multiple current accumulation terms such that each bit of the multiple current accumulation terms has a first data path delay from inputs to outputs of the summation circuitry, where n, S>=1; and
path matching circuitry comprising multiple components that receive a first clock signal to generate a second clock signal;
wherein the multiple components comprise either a first number of logic gates connected in series or the same first cells as those embedded in the summation circuitry such that the first data path delay substantially equals a first clock path delay from an input to an output of the path matching circuitry.

2. The circuit according to claim 1, further comprising:
a first register coupled to the summation circuitry for producing the multiple previous accumulation terms in response to the multiple current accumulation terms and the second clock signal; and
an adder coupled to the first register for adding the multiple previous accumulation terms in response to a control signal to generate a final accumulation value.

3. The circuit according to claim 1, further comprising:
a second register being responsive to the first clock signal, outputs of the second register being coupled to inputs of the PPG module,
wherein the multiple components further comprise either a second number of logic gates connected in series or the same second cells as those embedded in the PPG module such that a second data path delay from the inputs of the PPG module to the outputs of the summation circuitry substantially equals a second clock path delay from the input to the output of the path matching circuitry.

4. The circuit according to claim 1, further comprising:
a second register coupled between the PPG module and the summation circuitry and being responsive to the first clock signal.

5. The circuit according to claim 1, wherein the PPG module is divided into n PPG units, each of which receives one of the n multiplicands and one of the n multipliers based on the predefined multiplication algorithm to generate at least one of the multiple partial products.

6. The circuit according to claim 5, wherein the predefined multiplication algorithm is long multiplication and each of the n PPG units comprises:
m partial product generators for generating m of the multiple partial products according to the one of the n multiplicands and m bits in the one of the n multipliers, where 1<=m<=N and N denotes a bit width of the n multipliers.

7. The circuit according to claim 5, wherein each of the n PPG units comprises:
encoding circuitry for dividing N bits of the one of the n multipliers into multiple overlapping groups of b bits and sequentially encoding each of the multiple overlapping groups of b bits into an encoded output according to the predefined multiplication algorithm; and
a partial product generator for receiving the encoded output and the one of the n multiplicands to generate one of the multiple partial products, where b>1 and N denotes a bit width of the n multipliers.

8. The circuit according to claim 7, wherein each of the n PPG units further comprises:
a second register coupled between the encoding circuitry and the partial product generator and being responsive to the first clock signal.

9. The circuit according to claim 5, wherein each of the n PPG units comprises:
a division device for dividing N bits of the n multipliers into U overlapping groups of b bits and outputting m of the U overlapping groups of b bits in parallel, wherein b>1 and N denotes a bit width of the n multipliers;
m encoders for encoding the m of the U overlapping groups of b bits into m encoded outputs in parallel according to the predefined multiplication algorithm; and
m partial product generators for receiving the m encoded outputs and the one of the n multiplicands to generate m of the multiple partial products, where U>=m>=2.

10. The circuit according to claim 9, wherein each of the n PPG units further comprises:
a second register coupled between the m encoders and the m partial product generators and being responsive to the first clock signal.

11. The circuit according to claim 9, wherein the predefined multiplication algorithm is radix-4 Booth's multiplication, and wherein U=(N/2)+1 if N is an even integer and U=((N+1)/2)+1 if N is an odd integer.

12. The circuit according to claim 1, wherein the PPG module is implemented by a processor and a storage media.

13. The circuit according to claim 1, wherein the compressors at the same level have the same compression rate.

14. The circuit according to claim 2, wherein the summation circuitry comprises:
a compressor tree comprising s1 levels of the S levels of compressors in a path-symmetric configuration to compress the multiple partial products into multiple product terms,
wherein a number of the multiple partial products is greater than a number of the multiple product terms, where 1<=s1<S.

15. The circuit according to claim 14, wherein if the number of the multiple partial products is less than a number of inputs of compressors in Level 0, spare inputs of compressors in Level 0 are provided with zeroes and wherein if a number of outputs of compressors in Level (i−1) is less than a number of inputs of compressors in Level i, spare inputs of compressors in Level i are provided with zeroes, where 1<=i<=(s1−1).

16. The circuit according to claim 14, wherein the summation circuitry further comprises:
an accumulation circuitry coupled to the compressor tree and the first register and comprising s2 levels of the S levels of compressors for adding the multiple product terms and the multiple previous accumulation terms to produce the multiple current accumulation terms, where 1<=s2<S and s1+s2=S.

17. The circuit according to claim 16, wherein if a number of the multiple product terms plus a first number n1 of outputs of the first register coupled to the compressors in Level 0 is less than a number of the inputs of compressors in Level 0, spare inputs of compressors in Level 0 are provided with zeroes, and wherein if a number of outputs of compressors in Level (i−1) plus a second number n2 of the outputs of the first register coupled to the compressors in Level i is less than a number of the inputs of compressors in Level i, spare inputs of compressors in Level i are provided with zeroes, where 1<=i<=(s2−1) and n1, n2>=0.

18. The circuit according to claim 2, wherein the S levels of compressors are arranged in a path-symmetric configuration to compress the multiple partial products and the multiple previous accumulation terms into the multiple current accumulation terms, and wherein a number of the multiple partial products plus a number of the multiple previous accumulation terms is greater than a number of the multiple current accumulation terms.

19. The circuit according to claim 18, wherein if a number of the partial products plus a first number n1 of outputs of the first register coupled to the compressors in Level 0 is less than a number of the inputs of compressors in Level 0, spare inputs of compressors in Level 0 are provided with zeroes, and wherein if a number of outputs of compressors in Level (i−1) plus a second number n2 of the outputs of the first register coupled to the compressors in Level i is less than a number of the inputs of compressors in Level i, spare inputs of compressors in Level i are provided with zeroes, where 1<=i<=(S−1) and n1, n2>=0.
